(19) United States
(12) Patent Application Publication
(10) Pub. No.: US 2010/0079055 A1
(43) Pub. Date: Apr. 1, 2010

(54) PROVIDING AN IMPROVED THERMAL PATH TO ELECTRONICS BY OVERMOLDING IN A LIGHTING SOURCE

(75) Inventors: Bruce R. Roberts, Mentor-on-the-Lake, OH (US); Laszlo S. Ilyes, Richmond Heights, OH (US)

Correspondence Address: FAY SHARPE LLP, 1228 Euclid Avenue, 5th Floor, The Halle Building, Cleveland, OH, 44115, US

(73) Assignee: General Electric Company, Schenectady, NY (US)

(21) Appl. No.: 12/241,235

(22) Filed: Sep. 30, 2008

(51) Int. Cl. H01J 63/04; H01J 5/02; H01J 9/24

(52) U.S. Cl. 313/485; 313/324; 445/23

(57) ABSTRACT

A lamp assembly comprises a light source and an electrical base configured to connect with an associated power source. An electrical assembly is in electrical communication with the light source and the electrical base. The electrical assembly is configured to condition power received from the associated power source to operate the light source. A housing is formed of an overmolding material. The overmolded housing at least partially encapsulates the electrical assembly and is connected with the light source and the electrical base.

### BACKGROUND

The present disclosure generally relates to the lighting arts, and more particularly to overmolding an electrical assembly of a lamp assembly.

A conventional lamp assembly, such as a compact fluorescent light and an electronic halogen, typically comprises a light source and an electrical assembly or an electronic circuit assembly supported within a standard plastic or high temperature resistant plastic case for housing electronics for the light source. For low voltage lamps (i.e., a lamp that requires a voltage lower than the main, or line, voltage to which the lamps are connected because of the voltage rating of the light source), the electronic circuit assembly is configured to step-down the voltage. The conventional plastic case has a very low thermal conductivity and, therefore, tends to retain excess heat generated during operation of the light source inside an electronics area of the case.

One known approach for removing excess heat generated during operation is the use of metal heat sinks. A metal heat sink adds substantial cost and weight to the lamp assembly, and may be relatively inefficient at dissipating heat. To achieve good thermal coupling with the ambient, metal heat sinks typically include fins or other radiating structures, which further increases the weight and bulk of the heat sink.

In some other approaches, particularly in high heat applications, the electronic circuit assembly is potted using a thermally conductive material. Typically, the potting material is a two-component silicone or epoxy containing a suspended, thermally conductive fill material. This potting material is combined or mixed and then cured. The curing can add considerable time and equipment demands on production. While the potting material assists in the removal of heat, it is only a moderately effective conductor of heat. Further, the potting material typically does not have enough thermal mass by itself to dissipate the generated heat. Accordingly, potting is commonly employed in lighting assemblies in conjunction with the metal heat sink.

Accordingly, the present disclosure provides improved apparatus and method to increase thermal conductivity of a lamp assembly, which results in a lower electronic circuit assembly temperature, that overcome the above-mentioned limitations and others.

### BRIEF DESCRIPTION

In accordance with one aspect, a lamp assembly comprises a light source and an electrical base configured to connect with an associated power source. An electrical assembly is in electrical communication with the light source and the electrical base. The electrical assembly is configured to condition power received from the associated power source to operate the light source. A housing is formed of an overmolding material. The overmolded housing at least partially encapsulates the electrical assembly and is connected with the light source and the electrical base.

In accordance with another aspect, a method of manufacturing a lamp assembly is provided. An electrical base is attached to an electronic circuit assembly. A material is overmolded over at least portions of the electronic circuit assembly. The overmolding material solely forms a unitary free-standing housing for the electronic circuit assembly. The overmolding material has a high melting temperature and high thermal conductivity. The light source is electrically connected to the electronic circuit assembly.

### BRIEF DESCRIPTION OF THE DRAWINGS

FIG. 1 is a schematic side view and partly axial section of a conventional fluorescent lamp assembly.

FIG. 2 is a schematic side view and partly axial section of a fluorescent lamp assembly according to the present disclosure.

FIGS. 3A, 3B and 3C diagrammatically show an exemplary insert injection molding process for forming the free-standing high thermal conductivity material overmolding of the lamp of FIG. 2. FIG. 3A diagrammatically shows the lamp assembly components arranged between mating components of an insert injection mold. FIG. 3B diagrammatically shows the lamp assembly components inside the mating components of the insert mold, but before injection of the melted thermoplastic. FIG. 3C diagrammatically shows the lamp assembly components inside the mating components of the insert mold after injection of the melted thermoplastic.

FIG. 4 is a schematic side view and partly axial section of a conventional candle lamp assembly.

FIG. 5 is a schematic side view and partly axial section of a candle lamp assembly according to the one aspect of present disclosure.

FIG. 6 is partial schematic side view and axial section of a candle lamp assembly according to the another aspect of present disclosure.

FIG. 7 is a schematic side view and partly axial section of a conventional combination halogen lamp assembly.

FIG. 8 is a schematic side view and partly axial section of a combination halogen lamp assembly according to the yet another aspect of present disclosure

FIG. 9 is a cross-sectional view of the combination halogen lamp assembly of FIG. 8 taken generally along lines 9-9 of FIG. 8.

### DETAILED DESCRIPTION

It should, of course, be understood that the description and drawings of the lamp assemblies disclosed herein are merely illustrative, and that the various identified components of the lamp assemblies are merely terms of art that may vary from one manufacturer to another and should not be deemed to limit the present disclosure. It should be understood that the present disclosure can be utilized in combination with many lamp assemblies and is not limited to practice with the lamp assemblies described herein.

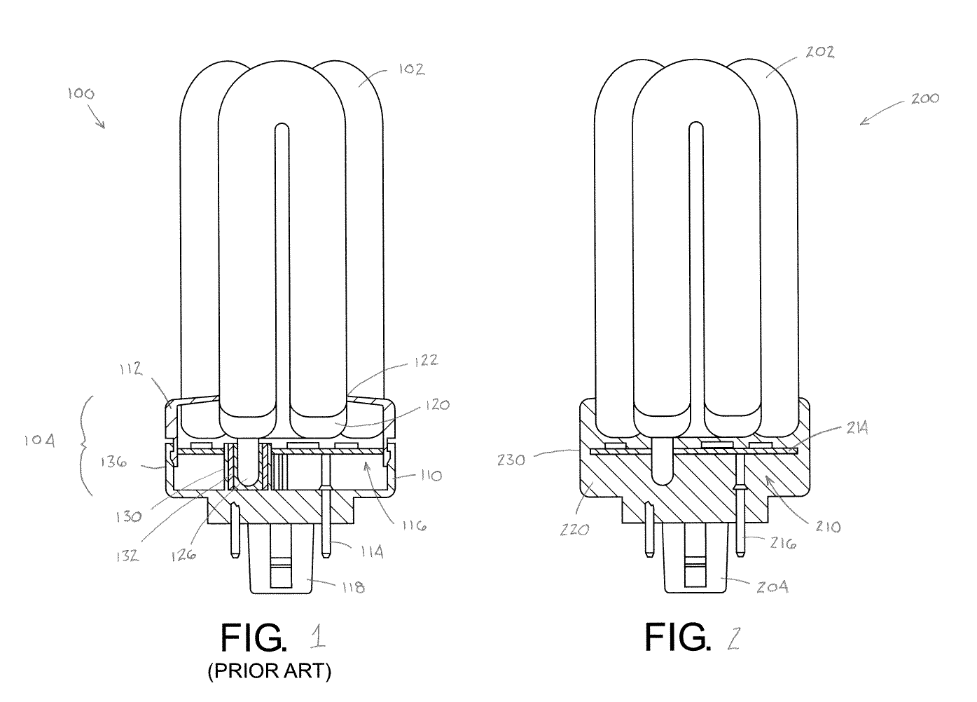

Referring now to the drawings, wherein like numerals refer to like parts throughout the several views, FIG. 1 illustrates an exemplary conventional compact fluorescent lamp assembly 100. The compact fluorescent lamp assembly 100 generally comprises a light source or discharge tube 102 and a housing 104. The housing includes a shell 110 and a separate cap 112. The shell and the cap are fitted to each other at their circumferential edges. The shell is provided with electrical connections 114 which make an electrical connection to a socket (not shown) and contact terminals built into an electronic circuit assembly 116. The light source is secured to the housing so that it does not become disconnected from either the outer housing or the electronic circuit assembly. A plug-in base 118 is connected to the cap.

In the depicted lamp, the discharge tube includes three U-shape tube sections, the ends 120 of which are bridged to each other in order to create a continuous path for the discharge arc. Although, it should be appreciated that the discharge tube can be a spiral, helix type discharge tube. The discharge tube 102 is filled with noble gas and mercury and its tube sections are sealed at their ends. These ends 120 of the U-shape tube sections protrude into the inner space of the housing 104 through openings 122 formed on the top of the cap 112 of the housing and are fixed firmly therein. One end of a tube section is furnished with a tubulation 126 communicating with the discharge tube 102. The tubulation can be filled with amalgam pellets (not shown) and extends down towards the bottom of the shell 110.

A heat conducting means is formed from the bottom of the shell 110 as a plastic extension 130 protruding from an inner surface portion of the shell and having a cavity therein. The cavity accepts the tubulation with a gap. The gap between the outside surface of the tubulation 126 and the inside surface of the cavity of the plastic extension 130 is filled with heat conductive material or potting material 132. The plastic extension 130 together with the heat conductive material 132 creates a thermal bridge which transfers the heat from the tubulation 126 and the electronic circuit assembly 116 to a surface 136 of the housing 104.

Typically, the potting material 132 is a two-component silicone or epoxy containing a suspended, thermally conductive fill material. This potting material is combined or mixed and then cured. For example, silicone paste is widely used for heat transfer in the electrical industry. The curing can add considerable time and equipment demands on production. While the potting material assists in the removal of heat, it is only a moderately effective conductor of heat.

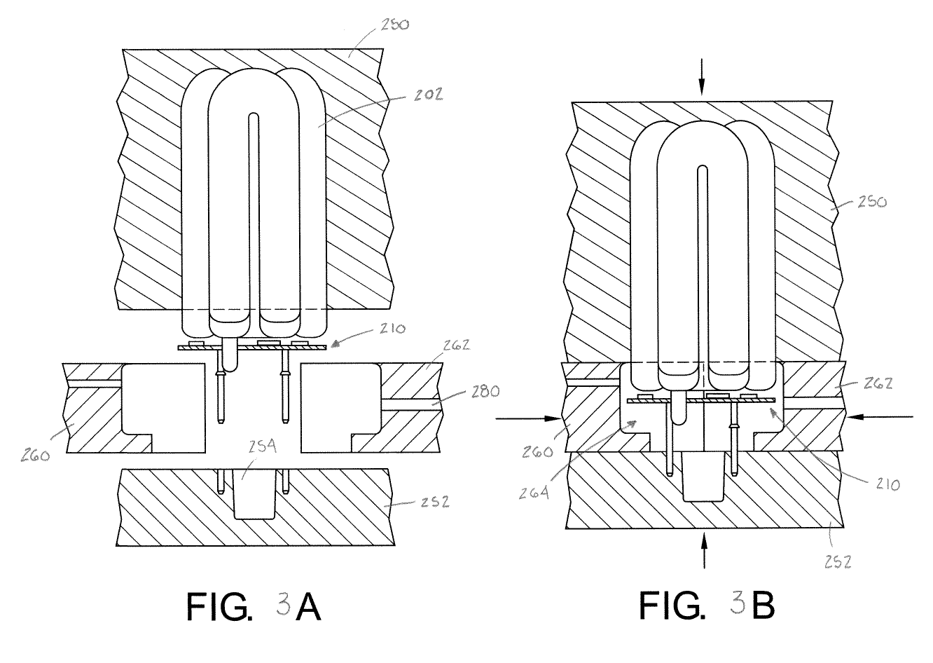

With reference to FIG. 2, an exemplary compact fluorescent lamp assembly 200 according to the present disclosure is illustrated. The lamp assembly 200 comprises a light source or discharge tube 202 and an electrical base, such as the plug-in base 204, configured to connect with an associated power source. An electrical assembly 210 is in electrical communication with the light source and the electrical base. The electrical assembly is configured to condition power received from the associated power source to operate the light source. The electrical assembly includes an electronic circuit assembly 214 and electrical connections 216 for connecting to the light source 202 to the electronic circuit assembly. A housing 220 is connected with the light source 202 and the electrical base 204.

The housing 220 is formed of a free-standing high thermal conductivity material overmolding. The overmolded housing encompasses or houses a portion of the light source and at least partially encapsulates the electrical assembly 210. In the depicted embodiment, the overmolding material completely encapsulates the electronic circuit assembly and at least a portion of each electrical connection. The overmolded housing 220 includes an external surface 230. At least a part of the external surface 230 of the overmolded housing 220 together with the light source 202 forms part of an external surface of the lamp assembly 200.

In some embodiments, the free-standing high thermal conductivity material used for the overmolding housing is a thermally conductive thermoplastic material or a thermally conductive thermoset material. In some embodiments, the free-standing high thermal conductivity material used for the overmolding housing is a thermally conductive and electrically insulating thermoplastic material. These encapsulation materials are suitable for use when encapsulating electronic components because they have low moisture permeability, favorable mechanical, electrical and physical properties, as well as a high thermal conductivity to dissipate heat generated by the devices. The proper choice of encapsulation material can enhance reliability of the device and improve its mechanical and physical properties. In this embodiment, the overmolding material has a melting temperature greater than about 100° C. and having a thermal conductivity greater than or about 0.8 W/mK. If an electrically conducting high thermal conductivity material is used, then any printed circuitry or other exposed conductors are typically coated with an insulative dielectric before disposing the electrically and thermally conductive high thermal conductivity material. On the other hand, electrically insulating high thermal conductivity material can be disposed onto conductors without an intervening insulative layer. The high thermal conductivity of the overmolded housing 220 removes the need for additional potting material. Further, the electrical assembly 210 does not need a separate metal core or other metal heat sink or potting material to dissipate heat.

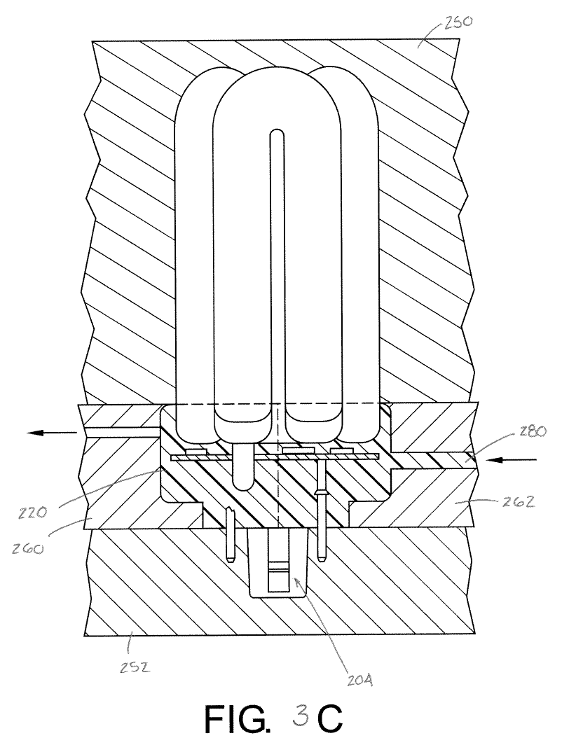

An exemplary method of manufacturing the lamp assembly 200 is provided. In some embodiments the free-standing high thermal conductivity material overmolding 202 is formed by insert molding. As shown in FIG. 3A, the light source 202 is positioned in an upper mandrel 250. A lower mandrel 252 includes a cavity 254 for receiving the electrical base 204 (see FIG. 3C). A portion of the electrical base can be positioned outside the mold for connection to an associated power source. The electrical assembly 210 is disposed between mating components 260, 262 of an insert mold. The light source 202 and electrical base 204 are attached to the electronic circuit assembly 210. FIG. 3B shows the two mating mold components 260, 262 after mating to form the closed insert mold having a cavity 264 containing the electrical assembly 210. The mold components 260, 262 can be designed with respective molding regions for forming respective first and second portions of the overmolded housing 202. In some embodiments, the molding regions allow the overmolding to encapsulate a predetermined section of the electrical assembly.

The high thermal conductivity material is overmolded over at least portions of the electrical assembly 210. Further, the electrical connections for connecting the electronic circuit assembly to the light source can be at least partially encapsulated with the overmolding material. Particularly, with reference to FIG. 3C, the thermally conductive thermoplastic or other high thermal conductivity molding material is typically supplied in pellets or other solid pieces (not shown) that are heated to form molten molding material that is delivered under pressure to the cavity by delivery conduits 280, such as a sprue and runners delivery system. Injected melted high thermal conductivity molding material 282 fills the molding cavity 264 where it solidifies to define the high thermal conductive overmolded housing 220. The overmolding material solely forms the unitary free-standing housing 220 for the electronic circuit assembly. The molding process seals the overmolded housing to the electrical base 204 by at least partially encapsulating the base with the overmolded housing, and attaches the light source 202 to the overmolded housing. This ensures that the light source is secured to the overmolded housing 220 so that it does not become disconnected from either the housing or the electrical assembly. The mold is then opened and the lamp assembly 200 is removed. Optionally, flash or other molding artifacts are trimmed off. The overmolded housing 220 forms at least a part of an external surface of the lamp assembly 200. Moreover, the entire overmolding process is completed with no post curing time or external heating.

The insert molding process described above is an illustrative example. Substantially any insert molding process can be employed to form the high thermal conductivity material overmolding housing 220. Because the lamp assembly 200 is removed from the mold 260, 262 after completion of the insert injection molding process, the lamp assembly suitably does not include a separate container or housing configured to contain the thermoplastic or other high thermal conductivity overmolding. Rather, the high thermal conductivity overmolding is free standing housing.

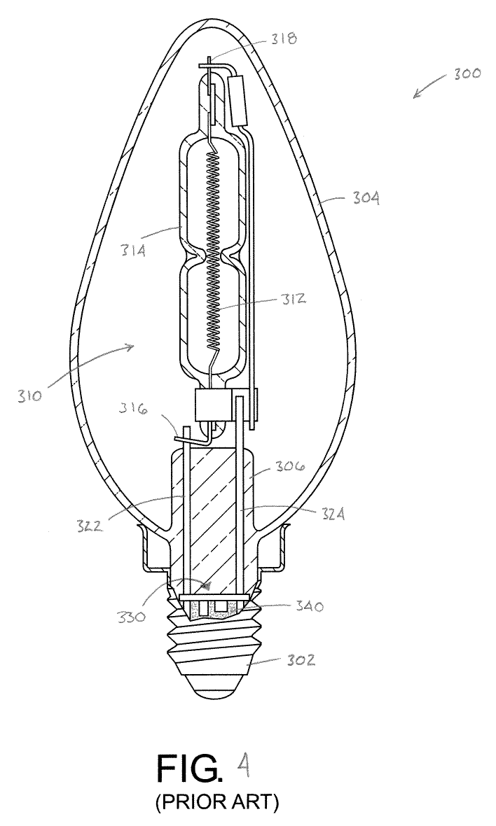

With reference now to FIG. 4, an exemplary conventional household candle lamp assembly 300 is illustrated. The lamp assembly 300 is equipped with an electrical lamp base 302 and a translucent outer envelope 304. The lamp base is connected to a stem 306 and the outer envelope. Though not shown in detail, the stem and the outer envelope are sealed in a region covered by the lamp base. A light source or halogen inner lamp 310 functions as the actual light source within the lamp assembly 300. This halogen inner lamp 310 contains a filament 312 in a halogen gas atmosphere, which latter is sealed within an inner lamp jacket 314. The filament 312 is connected to inner leads 316, 318. The inner leads of the inner lamp 310 are connected to leads 322, 324, respectively, in the stem 306, which are connected to the external contacts of the electrical base. The connection is an electrical (and typically also a mechanical) connection, such as point welding. An electrical assembly 330 located in a cavity defined by the electrical base 302 is in electrical communication with the light source 310 and the electrical base. The electrical assembly is configured to condition power received from the associated power source to operate the light source. A heat conducting potting material 340 is disposed within cavity of the electrical base 302.

With reference to FIG. 5, an exemplary household candle lamp assembly 400 according to the present disclosure is illustrated. The lamp assembly 400 comprises an electrical, Edison type screw base 402 configured to connect with an associated power source and a light source 410. An electrical assembly 430 is in electrical communication with the light source and the electrical base. The electrical assembly is configured to condition power received from the associated power source to operate the light source. The electrical assembly includes an electronic circuit assembly 432 and electrical connections 436 for connecting to the light source 410 to the electronic circuit assembly. A housing 440 is connected with the light source and the electrical base. The housing is formed of a free-standing high thermal conductivity material overmolding that at least partially encapsulates the electrical assembly 430.

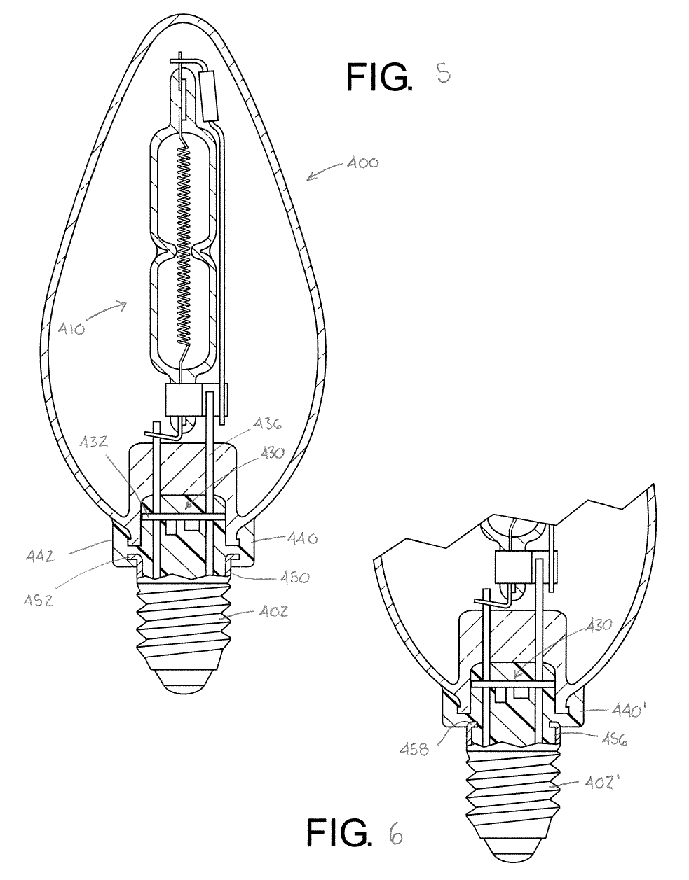

The overmolded housing includes and external surface 442 which forms at least part of an external surface of the lamp assembly 400. As shown, the overmolded housing seals against the electrical base forming an integral waterproof structure. In one embodiment (see FIG. 5), the electrical base includes an outer surface 450 and the overmolded housing 440 is sealed against the outer surface of the base. Particularly, the base includes outwardly extending projections 452 and the overmolding encapsulates the projections to fixedly secure the base to the overmolded housing. In another embodiment (see FIG. 6), the electrical base 402′ includes an inner surface 456 and the overmolded housing 440′ is sealed against the inner surface of the base. Particularly, the base includes inwardly extending projections 458 and the overmolding encapsulates the projections to fixedly secure the base to the overmolded housing. Similar to lamp assembly 200, the lamp assembly 400 does not include a potting material and/or a metal heat sink to dissipate the heat generated by the electrical assembly.

With reference now to FIG. 7, an exemplary conventional combination halogen lamp assembly 500 comprises a lamp housing 502 having a first upper section 504 secured to a second lower section 506. The housing sections together define an interior space of sufficient size to support a lamp 510, a retainer 512, and an electrical assembly 520. The electrical assembly is in electrical communication with the light source and an electrical base 522, which is configured to connect with an associated power source. Similar to the previous embodiments, the electrical assembly is configured to condition power received from the associated power source to operate the light source. The electrical assembly includes an electronic circuit assembly 530 and electrical connections 532 embedded in a stem 534 for connecting to the light source to the electronic circuit assembly. The lamp assembly may further include a retainer cap 540 which insures that the lamp 510 will not separate from the electrical assembly 520 contained in the housing 502. A heat conducting potting material 542 is disposed within housing and a heat sink 544 is provided on the electronic circuit assembly 530 to dissipate heat generated by the electrical assembly.

The lamp 510 can be a commercially available lamp, such as a General Electric Company halogen lamp, part number Q20MR16, which is used in prior art light fixtures having external electronic power converters. The lamp includes a reflector 550 and a cover glass lens (not shown). The cover glass lens encloses a lamp filament within the reflector. The reflector is preferably generally parabolic and has an elongated neck 552, generally rectangular in section, through which electrical pin connectors 554 of the lamp filament extend.

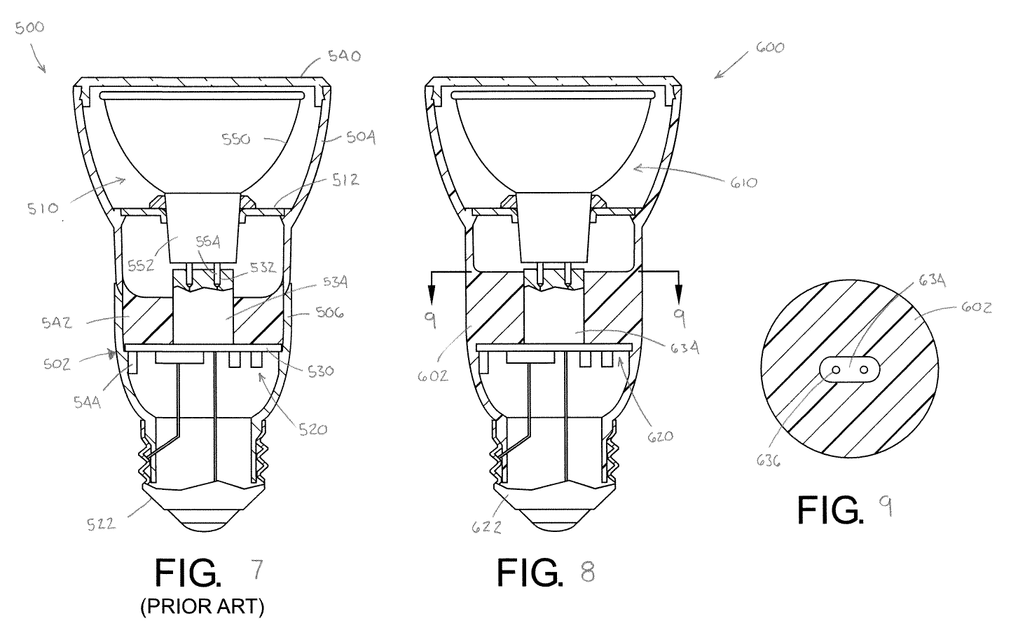

With reference to FIGS. 8 and 9, an exemplary combination halogen lamp assembly 600 according to the present disclosure is illustrated. The lamp assembly 600 comprises a housing 602 and an electrical base 622 fixedly secured to the housing. Particularly, the housing seals against an inner surface of the base to form an integral waterproof structure. The electrical base is configured to connect with an associated power source and a light source 610. An electrical assembly 620 is in electrical communication with the light source and the electrical base. The electrical assembly is configured to condition power received from the associated power source to operate the light source. A stem 634 having electrical connectors 636 for receiving electrical pin connectors of the light source is provided for connecting the light source to the electrical assembly. Similar to the previous embodiments, the housing 602 is formed of a free-standing high thermal conductivity material overmolding that at least partially encapsulates the electrical assembly 620. The overmolded housing also forms at least part of an external surface of the lamp assembly 600.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A lamp assembly comprising:
a light source;
an electrical base configured to connect with an associated power source;
an electrical assembly in electrical communication with the light source and the electrical base, the electrical assembly configured to condition power received from the associated power source to operate the light source; and
a housing formed of an overmolding material, the overmolded housing at least partially encapsulating the electrical assembly and connected with the light source and the electrical base.

2. The lamp assembly of claim 1, wherein the light source of one of incandescent, halogen and compact fluorescent.

3. The lamp assembly of claim 1, wherein the base is one of an Edison-type threaded base, a plug-in type base and a bayonet-type base.

4. The lamp assembly of claim 1, wherein the electrical assembly includes an electronic circuit assembly and electrical connections for connecting to the light source to the electronic circuit assembly, wherein the overmolded housing encapsulates at least a portion of each electrical connection.

5. The lamp assembly of claim 1, wherein the overmolded housing completely encapsulates the electrical assembly.

6. The lamp assembly of claim 1, wherein the overmolded housing seals against the base forming an integral waterproof structure.

7. The lamp assembly of claim 6, wherein the base includes an inner surface, the overmolded housing being sealed against the inner surface of the base.

8. The lamp assembly of claim 6, wherein the base includes an outer surface, the overmolded housing being sealed against the outer surface of the base.

9. The lamp assembly of claim 1, wherein the overmolding material has a melting temperature greater than about 100° C. and having a thermal conductivity greater than or about 0.8 W/mK.

10. The lamp assembly of claim 1, wherein the overmolded housing includes an external surface, wherein at least a part of the external surface forms part of an external surface of the lamp assembly.

11. The lamp assembly of claim 1, wherein the lamp assembly does not include a potting material.

12. A method of manufacturing a lamp assembly, the method comprising:
attaching an electrical base to an electronic circuit assembly;
overmolding a material over at least portions of the electronic circuit assembly, the overmolding material solely forming a unitary free-standing housing for the electronic circuit assembly, the overmolding material having a high melting temperature and high thermal conductivity; and
electrically connecting the light source to the electronic circuit assembly.

13. The method as set forth in claim 12, wherein the overmolding step comprises:
disposing the electronic circuit assembly and at least a portion of the electrical base in a mold;
introducing the overmolding material into the mold, the overmolding material encapsulating the electronic circuit assembly; and
removing from the electronic circuit assembly and electrical base with the secured overmolded housing from the mold.

14. The method as set forth in claim 13, wherein the overmolding material is a thermoplastic material or a thermoset material.

15. The method as set forth in claim 13, further comprising positioning a portion of the electrical base outside the mold for connection to an associated power source.

16. The method as set forth in claim 13, further comprising sealing the overmolded housing to the base.

17. The method as set forth in claim 13, further comprising at least partially encapsulating the base with the overmolded housing.

18. The method as set forth in claim 12, further comprising electrical connections for connecting the electronic circuit assembly to the light source, wherein the molding step comprises at least partially encapsulating the electrical connections with the overmolding material.

19. The method as set forth in claim 12, further comprising attaching the light source to the overmolded housing.

20. The method as set forth in claim 12, further comprising forming at least a part of an external surface of the lamp assembly with the overmolded housing.

21. The method as set forth in claim 12, wherein the entire overmolding step is completed with no post curing time or external heating.
